(19) United States
(12) Patent Application Publication
(10) Pub. No.: US 2023/0028343 A1
(43) Pub. Date: Jan. 26, 2023

(54) METHOD FOR SIMULATING AN ELECTRICAL CIRCUIT, SYSTEM FOR THE IMPLEMENTATION THEREOF, AND SIMULATING COMPONENT

(71) Applicant: Denis Aleksandrovich DAVYDOV, Ekaterinburg (RU)

(72) Inventor: Denis Aleksandrovich DAVYDOV, Ekaterinburg (RU)

(21) Appl. No.: 17/642,342

(22) PCT Filed: Nov. 14, 2019
(86) PCT No.: PCT/RU2019/000813

§ 371 Date: Jul. 7, 2022

(30) Foreign Application Priority Data
Jul. 25, 2019 (RU) 2019123419

(51) Int. Cl. G09B 23/18

(52) U.S. Cl. CPC G09B 23/185

(57) ABSTRACT

This invention relates to electric circuit simulation means, namely, an electrical circuit simulation technique, its implementation system and simulating component, and may be used in educational activities as a training aid, playing construction kit, breadboard, or test bench for teaching circuit engineering.

An electrical circuit simulation technique designed to be performed by a computing complex that is electrically coupled to at least one simulating component; the technique consists of the following: providing at least one electromagnetic coupling between at least two simulating components, of which at least one is electrically coupled to the computing complex; establishing a correspondence between each electromagnetically coupled simulating component and simulated electrical circuit element; computer simulation of the simulated electrical circuit consisting of electrical elements corresponding to the coupled simulating components and composed in such a way that an electrical coupling between the electrical circuit elements simulated by the simulating components corresponds to each electromagnetic coupling between the simulating components; reproduction of the results of computer simulation of the simulated circuit to the user.

### PERTINENT ART

This invention relates to electric circuit simulation means, namely, an electrical circuit simulation technique, its implementation system and simulating component, and may be used in educational activities as a training aid, playing construction kit, breadboard, or test bench for teaching circuit engineering.

### PRIOR ART

To assist in teaching circuit engineering and electric circuit simulation, various training kits comprising a support plane with working area arranged thereon and electrical units installed on such working area and equipped with real devices which are common electrical circuit elements have been developed. For example, such kits are disclosed in the patent for invention FR2412128 (IPC G09B23/18, publication date 22 Aug. 1980) and patent application GB2259177 (IPC G09B1/08, publication date Mar. 3, 1993). Both known similar technical solutions use a magnetic support substrate that allows for arranging electrical units with a magnetic fixation means in random order. Such substrate may also be ruled as a rectangular grid in order to enable positioning electrical units in specific cells. Electrical units can be interconnected with the help of electrical wire segments. By using conducting materials in electrical units, current flows in the assembled circuit when the latter is connected to a power supply. The use of magnets as a means of fixing the elements on the substrate prevents their unintentional displacement and allows for fixing the support substrate with the units installed thereon on any inclined surface.

A similar principle is implemented in an electronic construction kit disclosed in the Russian patent for utility model RU186799 (IPC A63H 33/04, publication date: 4 Feb. 2019). The known solution uses discrete radio-electronic elements, which are designed for assembling an electrical circuit on a working area. The solutions used in the known construction kit ensure compatibility with microprocessor boards, primarily Arduino, and with other training kits.

In other way, an assembly of the electrical circuit from terminating and conductive components is proposed in the Russian patent for useful model RU174016 (publication date: 25 Sep. 2017, corresponding patent is published as EP3363514, publication date 22 Aug. 2018). The known device comprises a power supply source consisting of a substrate with mounting pins on its upper side and mounting holes on its lower side, and a housing with an integrated processor and USB connector. The aforementioned pins and holes on the substrate and the USB connector are electrically connected to the processor. The device is placed on a breadboard provided with mounting pins to secure the power supply source and conductive and terminating components to it. These components also have locating pins and holes so that they can be connected to the pins and holes in the substrate to form electrical contact. The USB connector is designed to transmit and write a work program edited on an external electronic device, such as a personal computer, to the processor.

In yet another example known from patent for invention EP 1348209 (IPC G09B23/185, publication date 1 Oct. 2003), a breadboard for educational purposes is disclosed, which helps assemble electrical circuits consisting of electronic modular components. The breadboard consists of a housing, an assembling panel with a set of interleaved bonding pads which form a rectangular grid on this panel. The bonding pads include five terminal leads each that define possible spatial position of the modular component connected with them in four possible directions.

Patent application US2002/107679 (IPC G06F3/011, publication date 8 Aug. 2002) discloses a technique of creating virtual models of 2D and 3D objects assembled from modular components mounted on a supporting board. The supporting board is provided with a set of contacts, each of which has a given position on the board corresponding to them. The known technique contemplates constructing a virtual model that reflects the layout of the modular components mounted on the supporting board based on the data about the location of these components on the board, data for identification of the components and data about their properties obtained by computations with the values of current and voltage on the contacts connected with the modular components.

There are also known Edison Kit and Tesla Kit training kits by LightUp, Inc. (available at: https://www.lightup.io/app, accessed on: July 2019). The kit contains real electrical components that are connected by magnets for assembling an electrical circuit. When the user points the tablet camera at the assembled electrical circuit, special software enables visualization of the currents flowing inside the circuit and verification of the correct assembly. The components included in these kits are not linked with or controlled by a computing complex. The need to keep the tablet camera on the table and constantly point it at the assembled circuit causes inconvenience and risk of damage to the tablet.

It is also known that when teaching circuit engineering and programming with the use of microcontrollers, e.g. Arduino, solderless breadboards are used to assemble electrical circuits from real conductive electrical components such as LEDs, buttons, capacitors and the like. This approach allows for configuring simple electrical circuits to turn LEDs on and off, connect temperature and humidity sensors and LDRs, and operate such components, for example, change LED brightness through the use of Arduino software environment (Sources: Nussey J. Arduino for dummies.—John Wiley & Sons, 2013; Petin, V. A. Projects with Arduino controller. 2 ed.—BKhV-Peterburg, 2015).

However, technical solutions known in the prior art are characterized by a number of deficiencies, including, in the first instance, the need to use expensive or damageable devices, such as fast supercapacitors or diodes. Other deficiencies are the lack of possibility to integrate the assembled electrical circuit with a computer, which would enable automatic verification of the correct assembly and prompting in case of incorrect assembly. Some known technical solutions designed for simulation of real objects are limited in their field of application, as in the case of application US2002/107679. This solution is not adapted for performing simulation specifically of electrical circuits assembled from simulating components and makes it impossible to return to a user the data on the state of the assembled electrical circuit, for example the currents and potentials in different points of such circuit. These deficiencies of the known technical solutions generally limit their functionalities required for conducting effective simulation of the electrical circuit for educational purposes with the use of components that simulate real electrical devices and elements of electrical circuits.

### DISCLOSURE OF INVENTION

The technical problem this invention is aimed to solve consists in creating an effective and easy-to-use educational technical tool designed for electrical circuit simulation.

The technical result achieved in the implementation of this invention is to extend the functionality of the electrical circuit simulation implementation.

In accordance with the first aspect of the invention, an electrical circuit simulation technique is claimed which is designed to be performed by a computing complex electrically coupled to at least one simulating component, wherein the technique includes:

a. Providing at least one electromagnetic coupling between at least two simulating components, of which at least one is electrically coupled to the computing complex;
b. Establishing correlation between each electromagnetically coupled simulating component and a simulated electrical circuit element;
c. Computer simulation of the simulated electrical circuit that consists of the electrical elements that correspond to coupled simulating components and is arranged in such a way that each electromagnetic coupling between simulating components has a corresponding electrical coupling between the electrical circuit elements simulated by them;
d. Reproducing the results of computer simulation of the simulated circuit to the user.

In accordance with the second aspect of this invention, an electrical circuit simulation system is claimed for the implementation of the claimed technique, consisting of a computing complex, power supply source and simulating components of the first kind electrically interconnected between each other, with each simulating component of the first kind represented by a section of a dielectric plate common for all such components with at least one electromagnetic interaction unit and at least one means of fixation located on such section, wherein electromagnetic interaction units and means of fixation of each simulating component of the first kind are located on the common dielectric plate forming a rectangular grid, and each electromagnetic interaction unit enables an electromagnetic coupling with a simulating component other than the simulating component of which such unit is a part.

In accordance with the third aspect of the invention, a simulating component of the second kind is claimed, which enables the interaction with the claimed electrical circuit simulation system and comprise a functional unit coupled to at least one electromagnetic interaction unit and a means of fixation.

While studying scientific and technical, as well as patent literature, no combination of features identical to the combination of essential features set forth in the claims of this invention was found.

### BRIEF DESCRIPTION OF DRAWINGS

FIG. 1A to 1C show block diagrams of the electrical circuit simulation technique.

FIG. 2 shows an embodiment of a proper electrical circuit of the electrical circuit simulation system.

FIG. 3 shows an embodiment of the device used in the electrical circuit simulation system.

FIG. 4 shows a layout of the electromagnetic interaction units in the proper electrical circuit of the electrical circuit simulation system.

FIG. 5A to 5B show an example of conducting an electrical circuit simulation using training software for this invention embodiment.

### DESCRIPTION OF EMBODIMENTS OF INVENTION

The following detailed description of this invention with reference to the accompanying drawings is provided to illustrate it more clearly. However, it will be clear to persons skilled in the art that the inventive conception of this invention is not limited to these particular details.

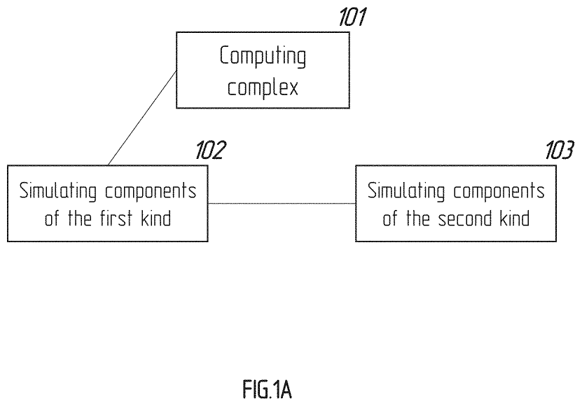

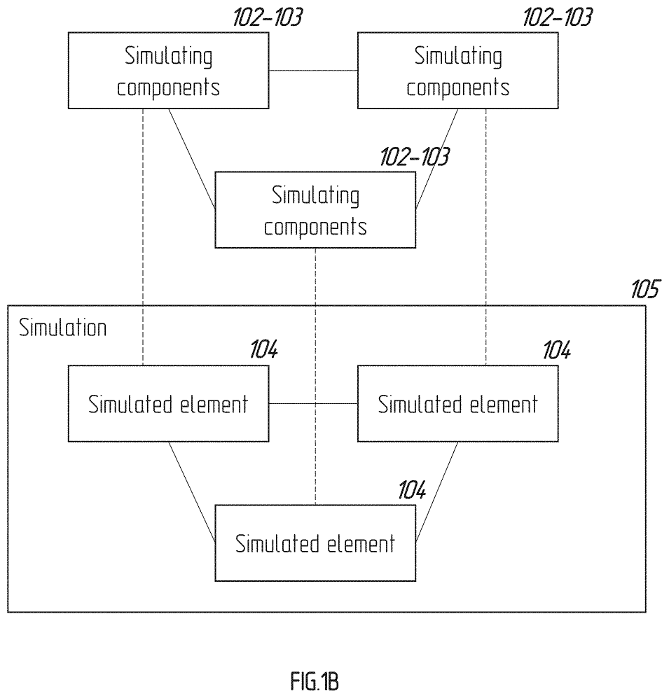

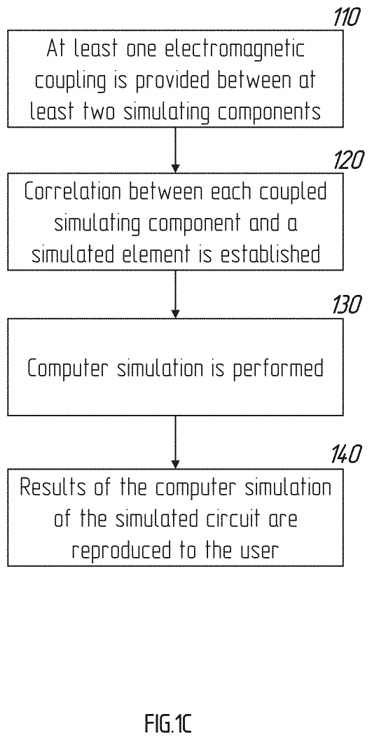

FIG. 1A shows a block diagram of the electrical circuit simulation technique in relation to the hardware and software of the claimed electrical circuit simulation technique. Hardware and software are incorporated in a computing complex 101 based on a microcontroller connected to a personal computer.

Another means for implementing the claimed technique are simulating components, which may be represented by simulating components of the first kind 102 or simulation components of the second kind 103. Simulating components 102-103 are designed to simulate real elements used to assemble electrical circuits, which are interconnected by means of electrical coupling that allows electrical current to flow. Such elements will be hereinafter referred to as “simulated elements” 104. Examples of simulated elements 104 may include transistors, diodes, connecting wires, and sensors. Moreover, parts of simulating components may include electric-light, electric-acoustic, electric-mechanical or other devices. All simulating components of the first kind 102 are electrically coupled to the computing complex via series-connected switches and analog-to-digital converters, and are located on a single dielectric plate common to all of the simulating components of the first kind 102. Simulating components of the first kind 102 are electrically connected to the power supply poles via switches. Simulating components of the second kind 103 are represented by devices designed to be placed on a dielectric plate and coupled to the simulating components of the first kind 102 to assemble the required electrical circuit and perform its simulation.

Simulating components of the first kind 102 are sections of a single dielectric plate with other parts of such components placed on both sides of the plate, which include an electromagnetic interaction unit linked with the computing complex that enables electromagnetic coupling with at least one of the other simulating components. Simulating component 102 of the first kind may optionally include an image of the simulated element placed on the section of the dielectric plate. For example, such image may imply a schematic indication of the polarity of the power supply pole. Moreover, simulating component 103 of the second kind may also comprise a schematic representation of the element simulated by it, e.g. a diode or a resistor, in accordance with the rules adopted in the field of electronic engineering for reference symbols of electrical elements in electrical circuits.

FIG. 1C shows a block diagram of the sequence of operations in the claimed electrical circuit simulation technique. In step 110, at least one electromagnetic coupling is established between at least two simulating components, of which at least one is electrically coupled to the computing complex. In one example, electromagnetic coupling may be established between two simulating components of the first kind 102, by means of an electrical wire. In another example, electromagnetic coupling may be established between simulating component of the first kind 102 and simulating component of the second kind 103: a diode, component of the second kind 103, may be coupled to a conductor, component of the first kind 102, or to two components, one of which is “conductor” and the other is “power supply pole”. Hereinafter, the bracketed name of the electrical component is used to mean “example of simulated component 104”, e.g. “diode” is a simulated diode. Simulating components 103 of the second kind are selected so as to enable the user to assemble an arbitrary electrical circuit to conduct its simulation. At the same time, multiple simulating components may be simultaneously used to assemble a single simulated electrical circuit, as needed.

Simulating component of the first kind 102 and simulating component of the second kind 103 include electromagnetic interaction units through which coupling between these components is established. Simulating component of the first kind 102 includes an electromagnetic interaction unit coupled to computing complex 101 that enables electromagnetic coupling with at least one of the other simulating components. The electromagnetic coupling allows for data exchange between simulating components of the first kind 102, second kind 103 and computing complex 101, as well as providing electric power supply to simulating components of the second kind 103 from the power supply source via simulating components of the first kind 102. Each electromagnetic interaction unit may be part of one, two or more simulating components of the first kind 102. In this case, for computer simulation purposes, the electromagnetic coupling to such unit is interpreted as electromagnetic coupling to at least one of a variety of simulating components of which such unit is a part.

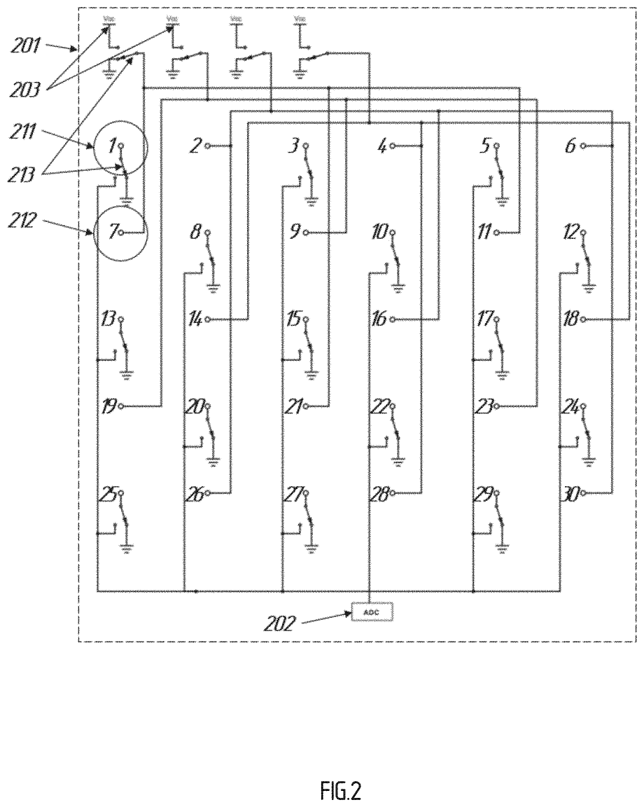

In one embodiment, each electromagnetic interaction unit is configured so as to enable contact interaction with the simulating component. In such case, the electromagnetic interaction unit may be represented by a terminal lead on the dielectric plate. FIG. 2 shows proper wiring diagram 201 of the electrical circuit simulation system, where terminal leads are numbered by positions 1 to 30. Such terminal lead ensures an electrical contact with terminal leads of the simulating component of the second kind 103 in case of contact between terminal lead surfaces, whereby the component is powered and analog or digital signals are exchanged with the computing module via analog-to-digital converter 202. Therein, to enable the electrical coupling, it is sufficient to ensure that simulating component of the second kind 103 contacts two terminal leads of simulating component of the first kind 102, which are connected to the opposite poles of the power supply source.

In another preferred embodiment, each electromagnetic interaction unit is designed so as to provide contactless interaction between simulating components of the first kind 102 and second kind 103. In such case, the electromagnetic interaction unit is represented by a PCB or wire induction coil. For example, the PCB coil may be presented as a conductive spiral track on the dielectric plate. When current flows through the PCB coil, electromagnetic field is induced, which enables power to be supplied to simulating component of the second kind 103 and signals to be exchanged with it. To enable electromagnetic coupling, it is sufficient to ensure interaction between one said coil placed on the dielectric plate and one coil placed on simulating component 103. It will be apparent to a person skilled in the art that various specific embodiments of electromagnetic coupling are possible in the present invention, for example providing electromagnetic interaction by means of the RFID (Radio Frequency Identification), wherein simulating component of the second kind 103 may have a transponder (RFID tag). In such embodiment, electromagnetic interaction units of simulating component of the first kind 102 on the dielectric plate section may be represented by reading machines.

However, there may be embodiments in which some of the electromagnetic interaction units are designed for contact interaction with the simulating components and some of such units are designed for contactless interaction. For example, simulating component of the second kind 103, when placed on the dielectric plate, may be simultaneously coupled to two electromagnetic interaction units designed for contact interaction for receiving power supply and to one electromagnetic interaction unit designed for contactless interaction for exchanging data with the computing module 101.

The electromagnetic interaction units of simulating components of the first kind 102 may be preferably placed on the dielectric plate to form a rectangular grid, with said units being placed at the intersections of vertical and horizontal lines of such grid similar to widely used solderless breadboards in which terminal leads are placed in parallel rows. This provides visual convenience when configuring electrical circuits from simulating components of the second kind 103, particularly for users who are skilled in assembling electrical circuits on breadboards. It is worth noting, however, that in various embodiments of the technique it is not necessary to strictly respect the rectangular shape of the grid. In particular, such grid may be made diamond-shaped or parallelogram-shaped, or in any other intuitively and visually perceptible form that makes it possible to conveniently arrange simulating components of the second kind 102 on the dielectric plate surface.

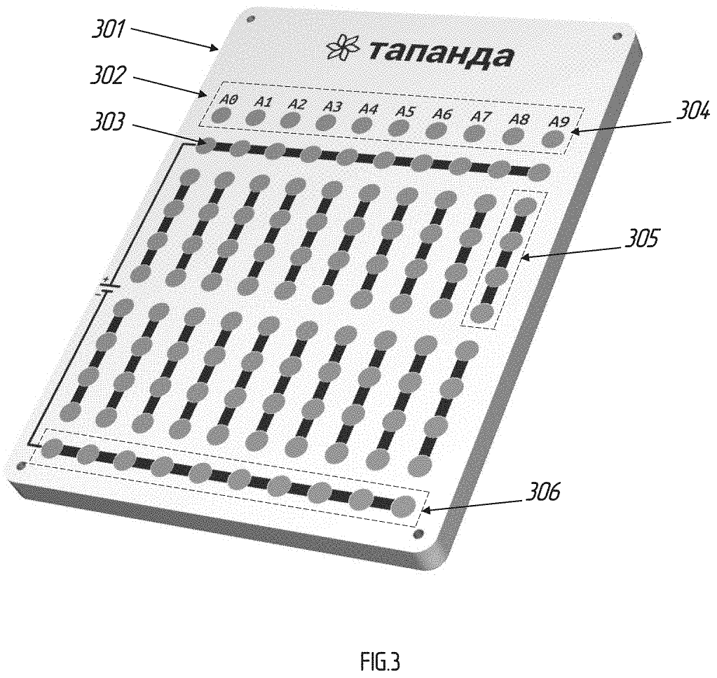

The principle of arranging the electromagnetic interaction units can also be more precisely understood in accordance with FIG. 3, that shows in detail front part 302 of device 301 used in the claimed electrical circuit simulation technique and the system for the technique implementation. Front part 302 covers the dielectric plate located in the housing of this device 301, but at the same time makes bonding pads 303 placed on the dielectric plate that form the said rectangular grid accessible to the user. Each bonding pad 303 consists of an electromagnetic interaction unit and a means of fixation for simulating component of the second kind 103. One preferred means of fixation is a magnet. However, it will be understood by persons skilled in the art that the means of fixation may also be implemented as an alternative embodiment, such as in the form of pins and mating holes that ensure securing the simulating components of the second kind 103 to the bonding pad 303. FIG. 3 shows as well the examples of simulating components of the first kind: simulated microcontroller outputs 304, simulated conductor 305 and simulated power supply pole 306. One simulating component of the second kind 103 may be preferably coupled to one or two electromagnetic interaction units to provide it with electrical power and enable the exchange of analog or digital signals. However, in various embodiments, electromagnetic coupling of a single simulating component to an arbitrary number of electromagnetic coupling units may be established.

Each electromagnetic interaction unit is characterized by its affiliation with at least one simulating component and state indicating the presence or absence of electromagnetic coupling of such unit to another simulating component. The dielectric plate may comprise an analog, digital or analog and digital circuit by means of which the state of all units of each simulating component of the first kind 102 is transmitted to computing complex 101. The affiliation of the interaction unit indicates which of the interacting simulating components it is a part of. If the simulating component is component of the first kind 102, the affiliation data also includes a reference number of the electromagnetic interaction unit, which may be selected from a range of values 1-30 on the rectangular grid, as illustrated in FIG. 2. The data on the unit state and affiliation may be digitally transmitted to the computing module, thereby providing a chart of coupled simulating components of the first kind 102 and second kind 103. This may be most preferable in the case where the electromagnetic interaction unit is configured so as to enable contactless interaction with the simulating component, and the simulating component is represented by a digital component provided with a microcontroller, which storage device keeps all its data in digital form.

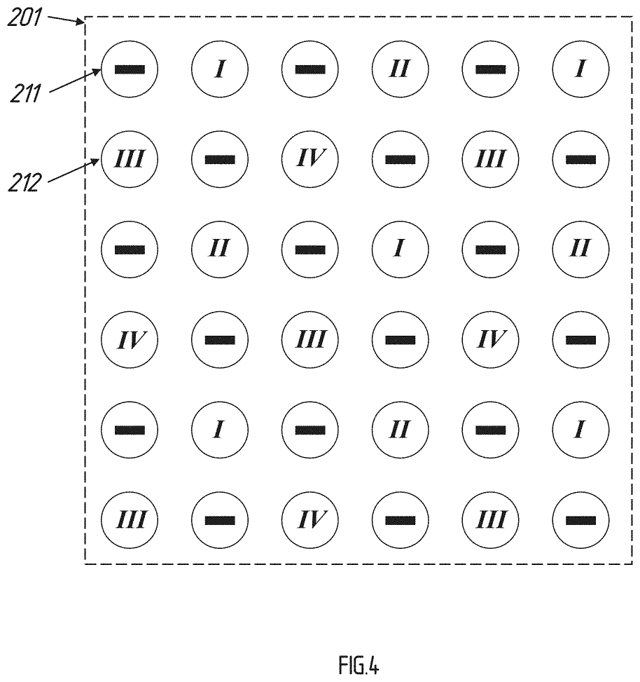

However, such chart may also be obtained in another way. For this purpose, the electromagnetic interaction units preferably represented by terminal leads on the dielectric plate may have a different execution, namely be represented by interaction units of the first type 211 and second type 212. Simulating components of the first kind 102 may have such dimensions and mutual arrangement that the electrical interaction units of first and second types appear to be staggered on the dielectric plate. The layout of the terminal leads is illustrated by the drawing shown in FIG. 4, where reference positions I to IV indicate electrical circuit channels 201 on which interaction units of the second type 212 are arranged. The terms “vertical” and “horizontal” as used in the description text and when stating the invention features in the claims of the present invention are to be understood as characterizing possible positions of the simulating component on the rectangular grid on the dielectric plate plane. For example, a vertical position of a simulating component on a rectangular grid is its position when interacting with a pair of adjacent terminal leads, that have reference numbers: 7 (extreme right contact in the second row of the rectangular grid) and 13 (extreme right contact in the third row of the grid) in FIG. 2. In another example, position of the simulating component when interacting with a pair of adjacent terminal leads located in the same row of the rectangular grid, with reference numbers 7 and 8, corresponds to a horizontal position of the simulating component.

Each electromagnetic interaction unit of the first type 211 is linked with a switch which enables switching the communication of such unit between the power supply pole and analog-to-digital converter 202, with analog-to-digital converter 202 being linked with computing complex 101.

Each interaction unit of the second type 212 is linked with one of four independent electrical channels, each of which is linked with a switch which enables switching of such channel between the power supply poles.

The electromagnetic coupling of simulating component of the second kind 103 with simulating components of the first kind 102 may be established by means of two electromagnetic interaction units of different types.

Each interaction unit of the first type 211 and interaction unit of the second type 212 are also characterized by a state indicating the presence or absence of coupling between such units and the simulating component. In determining the state of the electromagnetic interaction units of the second type, data on the state and affiliation of the electromagnetic interaction units of the first type, data on the size and mutual arrangement of the simulating components of the first kind, and data on the size of the simulating components of the second kind are used. In order to accurately determine which of the possible units have changed their state, in determining the affiliation of the electromagnetic interaction unit coupled to the simulating component, affiliation of interaction unit of the first type 211 and then of interaction unit of the second type 212 is primarily determined.

Establishing the affiliation of interaction unit of the first type 211 coupled to the simulating component is performed by successive check of each such unit 211 comprising in switching each of switches 213 coupled to interaction units of the first type 211. Such check assumes that at one point of time only one of possible interaction units 211 is in coupling position with computing complex 101 via switch 213. If, during the check, a signal is received by ADC 202 that interaction unit 211 being checked at a point of time has changed its state, the affiliation of the coupled unit is considered completed, and computing complex 101 receives data about the sequence number of the coupled unit or its coordinates (row and column) or reference number within the rectangular grid.

In another embodiment, establishing the affiliation of interaction unit of the first type 211 coupled to the simulating component is performed by successive check of the groups of such units 211. For example, the first half of all units 211 may be simultaneously checked first, followed by the check of the second half. If, during the check of a group of units 211, a signal is received by ADC 202 that one of the units 211 in the group being checked at a point of time has changed its state, the group is then re-divided into two parts and each of the parts is checked until affiliation of the unit to be coupled is accurately determined.

In order to determine which of the possible vertical or horizontal positions the simulating component occupies, establishing the affiliation of interaction unit of the second type 212 coupled to the simulating component is performed by successive check of the groups of such units 212, with each of these groups being placed on one channel. Given that there are four possible positions of the simulating component relative to one unit of the first type 211, units of the second type 212 are arranged on four channels I to IV, and each such channel is coupled to power supply 203 via switch 213. In order to determine the second terminal lead from the pair coupled to the simulating component, each of the channels I-IV is sequentially switched changing the state of each of four switches 213. For example, if the affiliation of the first unit of the first type 211 coupled to the simulating component has been established and its reference number 1 has been determined, the second unit from the possible pair may be adjacent unit 2 located on channel I or adjacent block 7 located on channel III. For example, if, during the check of a group of units 212, a signal is received by ADC 202 that one of the units 212 in the group of units 212 located on channel III being checked at a point of time has changed its state, the affiliation of unit of the second type 212 is considered completed, and computing complex 101 receives data about the sequence number 7 of the coupled unit 212.

In one embodiment, each of said switches 213 may be represented by a relay and/or a circuit of semiconductor devices. The switches are controlled by the computing complex. In another embodiment, a more complex circuit of semiconductor devices may be implemented to provide the necessary switching of each of the electromagnetic interaction units.

At step 120, correlation between each electromagnetically coupled simulating component and a simulated electrical circuit element is established. Determination of the correspondence between simulating component of the second kind 103 and the simulated element of the electrical circuit is performed by obtaining an identifier of such simulating component and comparing such identifier with an identifier in the memory of computing complex 101. For some simulating components of the second kind 103, the identifier may be represented by a numerical code stored in the memory device of such component, for others—by an analog signal generated by the electrical circuit of the simulating component; in yet another embodiment—by impedance of the simulating component electrical circuit; in yet another embodiment—by width and frequency of pulses generated by the component electrical circuit. Determination of the correspondence 102 may be conducted according to the referencing principle. The reference identifier value required to determine the correspondence of simulating component of the second kind 103 with the simulated component of the electrical circuit may be stored in the memory device of computing complex 101.

At step 130, computer simulation is performed for the simulated electrical circuit that consists of the electrical elements that correspond to coupled simulating components and is arranged so that each electromagnetic coupling between simulating components has a corresponding electrical coupling between the simulated electrical circuit elements.

Let us get back to FIG. 1B which shows a block diagram of the electrical circuit simulation technique in relation to the hardware and software of the claimed electrical circuit simulation technique. Having established the electromagnetic coupling between the components, obtained data on the state of the electromagnetic interaction units, their affiliation with the simulating components and established a correspondence between the simulating components and simulated elements, computer simulation 105 is performed, the result of which is a computer model that reflects the quantitative and qualitative composition of the simulated electrical circuit. For this purpose, algorithms for calculating electrical circuits, such as an algorithm for calculating values of currents and potentials on the simulated elements of the electrical circuit according to Kirchhoff rules may be stored in computer complex 101.

For the data about the simulated electrical circuit generated at the terminals of steps 110 and 102, it may be possible to store them in the memory device of computing complex 101, for example, in the form of a tabular database. Such database may be automatically created at the start of a session of computing complex 101. If electromagnetic coupling between one or more of the simulating components and other simulating components is interrupted during the session of computing complex 101, the data on affiliation and state of the interaction units and identifiers of these components will be deleted from the database. For the components whose electromagnetic coupling has not been interrupted during such session, the data including the affiliation of the electromagnetic interaction units and correspondence of the simulating components will remain in that database, thus eliminating the need to re-assess the affiliation of the interaction units and determine the correspondence of the components. In addition, the simulated electrical circuit is re-simulated each time the simulated electrical circuit is altered when removing or incorporating new simulating components.

State and/or properties can be defined for the simulated components that are used in the computer simulation of the simulated electrical circuit.

At least one simulating component can be fitted with a sensor, and readings from this sensor can also be used in the computer simulation of the simulated electrical circuit.

At least one simulating component of the first kind is configured so as to simulate a microcontroller. In the computer simulation of the simulated circuit containing the microcontroller, computing complex 101 uses data received from the user regarding the electrical potential and internal impedance of the simulated microcontroller pins. Computing complex 101 must support software and/or graphical interface that allows the user to enter data about the electrical potential and internal impedance of the simulated microcontroller pins. In this way, simulation of operation with microcontroller is implemented.

At step 140, the results of the computer simulation of the simulated circuit are reproduced to the user. Reproduction may be accomplished by means of control of indicating, electric-light, electric-mechanical and other devices that are part of the simulating components. Concurrently, reproduction may be implemented by displaying such results in textual and/or visual form using a computer monitor or other multimedia device.

Reproduction of the results to the user with the use of the computer monitor may be provided with the help of the graphical interface of a client application installed on the user's computer, or a web interface, provided that interaction between the user and the electrical circuit simulation system is provided with the help of the web application. In order to enable various types of electronic interaction, including data exchange over the network, with any external computing means, computing system 101 may have one or more appropriate communication interfaces. Such interfaces may ensure data exchange via wired or wireless data transmission protocols. Examples of communication interfaces are USB, RJ-45 or Wi-Fi interfaces.

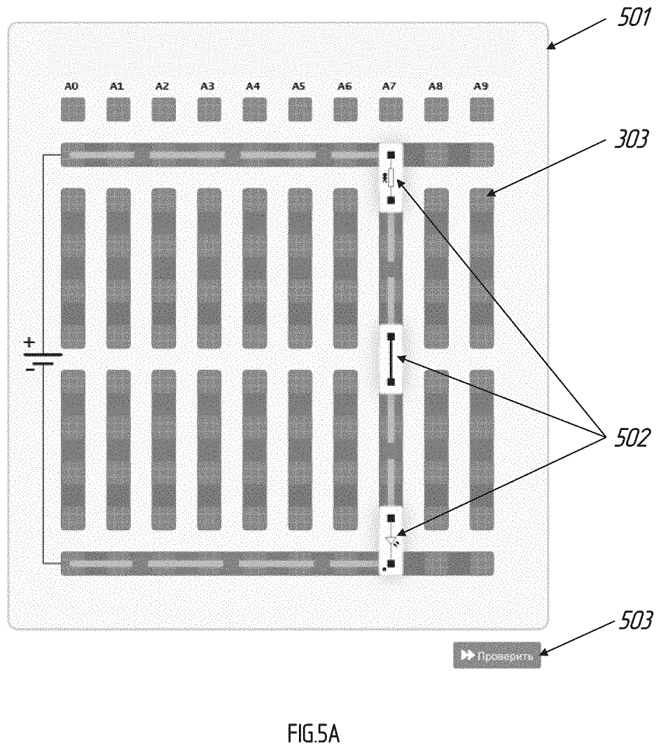

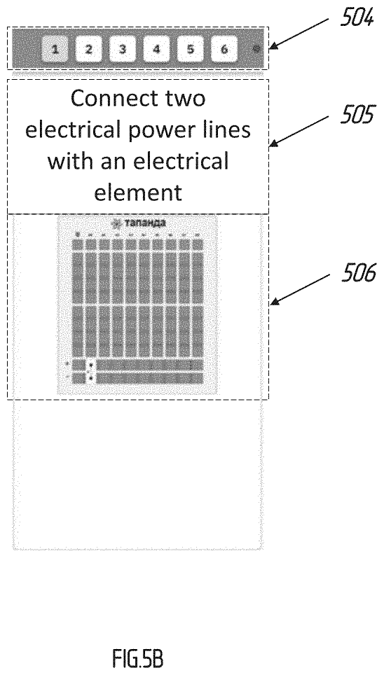

FIG. 5A shows a fragment of the graphical user interface used to return data on the simulated electrical circuit to the user. Working area 501 shows the position of identified simulating components 502 on bonding pads 303. When “Verify” button 503 is pressed, information about the correct assembly of the electrical circuit is returned to the user.

FIG. 5B shows a fragment of the graphical user interface used to issue tasks to the user concerning assembly of electrical circuits. Buttons 504 are used to navigate between tasks, field 505 is used to return to the user the wording of the task for electrical circuit assembly, and field 506 is used to return to the user the correct answer to the task.

In this way, when the results of the computer simulation are presented to the user, the users may have a feeling that they are working with a real electrical circuit.

Simulating component of the second kind 103 designed to interact with the claimed electrical circuit simulation system comprises a functional unit, at least one electromagnetic interaction unit coupled with it, and a means of fixation.

In one embodiment, simulating component 103 may be represented by an analog simulating component whose functional unit consists of the electrical circuit comprising at least one resistor and/or capacitor and/or diode and/or induction coil. The above electrical circuit may additionally have a sensor that alters the analog signal generated by such circuit to identify the simulating component, or that alters the electrical impedance of such circuit. Such alternation of the signal or impedance allows determining a sensor reading, and at the same time not preventing the identification of the simulating component. For example, the sensor readings and identifier may be transmitted in different signal frequency components or in different impedance components. Similarly, the above electrical circuit may comprise an active element, such as a LED, which is controlled by changing the voltage on terminals of the simulating component.

In another embodiment, simulating component 103 is represented by a digital simulating component whose functional unit consists of the microcontroller used to manage the data about that component and transmit it to the computing complex of the electrical circuit simulation system. The functional unit of such component may also comprise a sensor and enable reading and transmitting sensor readings to the system computing complex 101. Similarly, the above functional unit may comprise an active element, such as a LED, and enable receiving data from computing complex 101 of the system for controlling this element.

Simulating component 103 may comprise two electromagnetic interaction units represented by terminal leads. In such case, the signal is transmitted to the computing module of the electrical circuit simulation system by changing the electrical impedance or by changing voltage between its terminal leads. The signal is received by the simulating component by means of changing the voltages at the terminal leads.

The simulating component may also comprise one electromagnetic interaction unit designed so as to enable contactless interaction with the electrical circuit simulation system. For example, such unit may be represented by a PCB coil, which is made in the form of a conductive spiral track on the dielectric plate. When current flows through the PCB coil, electromagnetic field is induced which enables power to be supplied to the simulating component and analog or digital signals to be transmitted to the computing complex.

The functional unit of the simulating component may be additionally represented by the electrical circuit comprising a pulse generator that generates pulses of a given frequency and duration that serve to identify such component.

The means of fixation of the simulating component may be represented by a magnet.

A finished product made using this invention may include a construction kit comprising a breadboard including simulating components of the first kind and simulating components of the second kind aimed at assembling electrical circuits on such breadboard. The user of such construction kit may be a child learning circuit engineering and programming. The functions of the breadboard can be performed by the device shown in FIG. 3, whose front panel has bonding pads arranged in a rectangular grid. The front panel can also be labelled to help guide a child through the assembly of the electrical circuit, e.g. by depicting the power supply indicative poles (plus and minus). Each simulating component of the second kind then included in the construction kit can also be labeled with designations to help a child understand what real element of the circuit it corresponds to. These symbols can be common and standardized symbols for diodes, transistors, resistors and the like. One simulating component of the second kind may occupy a space of two bonding pads when mounted on a breadboard.

For example, a simple LED ignition circuit can be assembled on a breadboard, consisting of the components, such as “LED”, “resistor” and “power supply”. For the assembled electrical circuit, the current flowing through the LED is automatically calculated, and the LED lights up at the corresponding simulating component with the intensity corresponding to the amperage. In addition, the computer screen shows the electrical circuit that has been assembled, the current flowing in the circuit and the potential difference between the terminals of the resistor and the current source.

If it is assumed that a child is taught through an electronic educational resource, the graphical user interface can also serve to give the pupil tasks for the assembly of the electrical circuit. In addition, the transfer of data about the assembled circuit to the computer enables automatic checking of the assembly, prompting in case of incorrect assembly and issuing a new task. The principle of operation presented in this description allows for applying almost unlimited range of simulating components mounted on the breadboard, which allows the claimed invention to be used in a wide variety of applications.

1. An electrical circuit simulation technique is claimed which is designed to be performed by a computing complex electrically coupled to at least one simulating component, wherein the technique includes:
a. Providing at least one electromagnetic coupling between at least two simulating components, of which at least one is electrically coupled to the computing complex;
b. Establishing correlation between each electromagnetically coupled simulating component and a simulated electrical circuit element;
c. Computer simulation of the simulated electrical circuit that consists of the electrical elements that correspond to coupled simulating components and is arranged in such a way that each electromagnetic coupling between simulating components has a corresponding electrical coupling between the electrical circuit elements simulated by them;
d. Reproducing the results of computer simulation of the simulated circuit to the user.

2. The technique according to claim 1, wherein each simulating component is represented by a simulating component of the first kind or a simulating component of the second kind.

3. The technique according to claim 2, wherein all simulating components of the first kind are electrically coupled to the computing complex.

4. The technique according to claim 2, wherein all simulating components of the first kind are represented by sections of a single dielectric plate with other parts of such components placed on both sides of the plate.

5. The technique according to claim 4, wherein simulating component of the first kind includes an image of the simulated element placed on the dielectric plate section.

6. The technique according to claim 4, wherein simulating component of the first kind includes an electromagnetic interaction unit through which electromagnetic coupling of such simulating component with at least one of other simulating components is established.

7. The technique according to claim 6, wherein each electromagnetic interaction unit is a part of one, two or more stimulating components of the first kind, wherein for the purposes of computer modelling the electromagnetic coupling to such unit is interpreted as electromagnetic coupling to at least one of a variety of simulating components of which such unit is a part.

8. The technique according to claim 7, wherein at least one electromagnetic interaction unit is configured so as to enable contact interaction with the simulating component.

9. The technique according to claim 8, wherein at least one electromagnetic interaction unit is represented by a terminal lead.

10. The technique according to claim 9, wherein the electromagnetic coupling between the simulating components of the first kind is provided by means of an electrical wire.

11. The technique according to claim 7, wherein at least one electromagnetic interaction unit is configured so as to enable contactless interaction with the simulating component of the second kind.

12. The technique according to claim 11, wherein at least one electromagnetic interaction unit is represented by a PCB or wire induction coil.

13. The technique according to claim 7, wherein each electromagnetic interaction unit is characterized by its affiliation with at least one simulating component and state indicating the presence or absence of electromagnetic coupling of such unit to the simulating component of the second kind.

14. The technique according to claim 13, wherein an analog, digital or analog and digital circuit is placed on the dielectric plate by means of which the state of all electromagnetic interaction units of each simulating component of the first kind is transmitted to the computing complex.

15. The technique according to claim 8, wherein each electromagnetic interaction unit is represented by an interaction unit of the first type or interaction unit of the second type, while the simulating components of the first kind have such dimensions and mutual arrangement, in which such units of the first and second types appear to be staggered on the dielectric plate.

16. The technique according to claim 15, wherein the electromagnetic coupling between the simulating component of the second kind and the simulating components of the first kind is established by means of two electromagnetic interaction units of different types.

17. The technique according to claim 16, wherein for determining the state of the electromagnetic interaction units of the second kind, data on the state and affiliation of the electromagnetic interaction units of the first kind, data on the size and mutual arrangement of the simulating components of the first kind, and data on the size of the simulating components of the second kind are used.

18. The technique according to claim 17, wherein the state of the interaction units of the first type is determined by means of successive check of each unit.

19. The technique according to claim 17, wherein the state of the interaction units of the first type is determined by means of successive check of the groups of such units.

20. The technique according to claim 17, wherein the state of the interaction units of the second type is determined by means of successive check of the groups of such units.

21. The technique according to claim 4, wherein determination of the correspondence between the simulating component of the second kind and the simulated element of the electrical circuit is performed by obtaining an identifier of such simulating component and comparing such identifier with an identifier in the memory of the computing complex.

22. The technique according to claim 21, wherein the identifier of the simulating component of the second kind is represented by a numerical code stored in the memory device of such component.

23. The technique according to claim 21, wherein the identifier of the simulating component of the second kind is represented by an analog signal generated by the electrical circuit of such component.

24. The technique according to claim 21, wherein the identifier of the simulating component is represented by the impedance of the simulating component electrical circuit.

25. The technique according to claim 21, wherein the identifier of the simulating component is represented by the width and frequency of pulses generated by the electrical circuit of such component.

26. The technique according to claim 1, wherein state and/or properties are defined for the simulated elements that are used in the computer simulation of the simulated electrical circuit.

27. The technique according to claim 1, wherein at least one simulating component has a sensor, and readings from this sensor are used in computer simulation of the simulated electrical circuit.

28. The technique according to claim 1, wherein reproduction of the computer simulation results to the user is performed by means of control of the indicating, electric-light, electric-acoustic, electric-mechanical and other devices that are part of the simulating components.

29. The technique according to claim 1, wherein reproduction of the computer simulation results to the user is performed by displaying such results in textual and/or visual form using a computer monitor or another multimedia device.

30. The electrical circuit simulation system for the implementation of the technique according to claim 1, consisting of a computing complex, a power supply source and simulating components of the first kind, which are electrically interconnected between each other, with each simulating component of the first kind represented by a section of a dielectric plate common for all such components with at least one electromagnetic interaction unit and at least one means of fixation located on such section, wherein the electromagnetic interaction units and means of fixation of each simulating component of the first kind are located on the common dielectric plate forming a rectangular grid, and each electromagnetic interaction unit enables an electromagnetic coupling with a simulating component other than a simulating component of which such unit is a part.

31. The system according to claim 30, wherein all simulating components of the first kind are electrically connected to the computing complex via series-connected switches and analog-to-digital converters.

32. The system according to claim 30, wherein the simulating components of the first kind are electrically connected to the power supply poles via switches.

33. The system according to claim 30, wherein each electromagnetic interaction unit is represented by an electromagnetic interaction unit of the first type or the second type.

34. The system according to claim 33, wherein the electromagnetic interaction units of the first and second types are staggered on the dielectric plate.

35. The system according to claim 31, wherein each electromagnetic interaction unit of the first type is connected to a switch which enables switching the communication of such unit between the power supply pole and analog-to-digital converter, with the analog-to-digital converter being connected to the computing complex.

36. The system according to claim 31, wherein each interaction unit of the second type is connected with one of four independent electrical channels, each of which is connected with a switch which enables switching of such channel between the power supply poles.

37. The system according to claim 31, wherein the switches are represented by a circuit of relays and/or semiconductor devices.

38. The system according to claim 31, wherein the switches are controlled by the computing complex.

39. The system according to claim 30, wherein the means of fixation of the simulating component is represented by a magnet.

40. The system according to claim 30, wherein at least one simulating component of the first kind is configured so as to simulate a microcontroller.

41. The system according to claim 40, wherein during the computer simulation of the simulated circuit comprising a microcontroller, the computing complex uses data received from the user regarding the electrical potential and internal impedance of the simulated microcontroller pins.

42. The system according to claim 41, wherein the computing complex supports a software and/or graphical interface that allows the user to enter data on the electrical potential and internal impedance of the simulated microcontroller pins.

43. The simulating component of the second kind designed so as to enable interaction with the electrical circuit simulation system according to claim 30, and which comprise a functional unit, at least one electromagnetic interaction unit coupled with it, and a means of fixation.

44. The simulating component according to claim 43, which is represented by an analog simulating component, the functional unit of which consists of an electrical circuit that includes at least one element represented by a resistor, capacitor, diode, or induction coil.

45. The simulating component according to claim 44, wherein the functional unit consists of an electrical circuit additionally provided with a sensor that changes the analog signal generated by such circuit to identify the simulating component.

46. The simulating component according to claim 44, wherein the functional unit consists of an electrical circuit additionally provided with a sensor that changes the electrical impedance of such circuit.

47. The simulating component according to claim 43, which is represented by a digital simulating component, the functional unit of which comprises a microcontroller used to manage the data about that component and transmit it to the computing complex of the system according to claim 30.

48. The simulating component according to claim 47, wherein the functional unit additionally comprises a sensor and enables reading and transmitting sensor readings to the computing complex of the system according to claim 30.

49. The simulating component according to claim 43, which comprises two electromagnetic interaction units represented by terminal leads.

50. The simulating component according to claim 49, which is configured so as to enable signal transmission to the computing complex of the system according to claim 30 by means of changing the electrical impedance between its terminal leads.

51. The simulating component according to claim 49, which is configured so as to enable signal receiving by means of changing the voltage between its terminal leads.

52. The simulating component according to claim 43, wherein the functional unit is represented by an electrical circuit comprising a pulse generator that generates pulses of a given frequency and duration that serve to identify such component.

53. The simulating component according to claim 43, wherein the electromagnetic interaction unit is configured so as to enable contactless interaction with the system according to claim 30.

54. The simulating component according to claim 43, wherein the means of fixation is represented by a magnet.
